(19) United States
(12) Patent Application Publication
(10) Pub. No.: US 2025/0314500 A1
(43) Pub. Date: Oct. 9, 2025

(54) METHOD AND SYSTEM FOR DISPLAYING POINT OF INTEREST

(71) Applicant: HYUNDAI AUTOEVER CORP., Seoul (KR)

(72) Inventors: Hee Eun LEE, Seoul (KR); Won Heung JO, Seoul (KR); Esther CHOI, Seoul (KR); Joo Ho CHAE, Seoul (KR); Il Kyun KIM, Seoul (KR); Min Jeong KIM, Seoul (KR); Yeon Kyung CHUNG, Seoul (KR); Hwa Hyeon HONG, Seoul (KR); Rak Jun SUNG, Seoul (KR)

(21) Appl. No.: 18/959,934

(22) Filed: Nov. 26, 2024

(30) Foreign Application Priority Data
Apr. 5, 2024 (KR) 10-2024-0046433

(51) Int. Cl. G01C 21/34; G01C 21/36

(52) U.S. Cl. CPC G01C 21/3476; G01C 21/3614; G01C 21/3641; G01C 21/3682

(57) ABSTRACT

Methods and systems for displaying a point of interest, performed by a computing device, are described. According to one embodiment, a method comprises acquiring data regarding a user-specified route and a user profile, searching for a point of interest of a group corresponding to the user profile, wherein the point of interest is located on the user-specified route, and displaying the point of interest on a map displayed by the computing device.

### CROSS-REFERENCE TO RELATED APPLICATION

This application claims priority from Korean Patent Application No. 10-2024-0046433 filed on Apr. 5, 2024, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and system for displaying a point of interest, and more particularly to a method and system for displaying a point of interest that display different points of interest depending on the user when providing a navigation service.

### 2. Description of the Related Art

When providing a navigation service, a service provider providing the navigation service builds a separate database and provides a service that recommends and displays different points of interest depending on the user's personal information.

However, when the service provider provides the service, the service provider needs to build a separate database to recommend a point of interest when determining whether a place matches the preferences depending on the user's personal information.

Therefore, there is a need for a technology that recommends a place that matches the preferences depending on the user's personal information and displays the place on a map without the service provider having to build the separate database.

### SUMMARY

Aspects of the present disclosure provide a method and system for displaying a point of interest by searching for a point of interest of a user group corresponding to user's profile information and displaying the point of interest on a map, in providing a navigation service.

Aspects of the present disclosure also provide a method and system for displaying a point of interest by searching for a place corresponding to user's profile information without building a separate database and displaying the place on a map, in providing a navigation service.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for displaying a point of interest, performed by a computing device. The method may comprise acquiring data regarding a user-specified route and the user's profile; searching for a point of interest of a group corresponding to the profile, the point of interest being located on the route; and displaying the searched point of interest on a map displayed by the computing device.

In some embodiments, the data regarding the profile may include data input by the user and data set by the computing device.

In some embodiments, the acquiring of the data includes identifying a passenger riding inside a mobility device equipped with the computing device, and the data regarding the profile further includes data regarding the relationship between the passengers and the user, when the number of passengers is multiple.

In some embodiments, the data regarding the profile may further include data regarding an age range of the passenger, when the passenger is a child of the user as a result of performing the identifying of the passenger.

In some embodiments, the acquiring of the data may include acquiring data regarding a profile item selected by the user among the profile items included in an social media search filter.

In some embodiments, the searching for the point of interest may include searching for the point of interest from an social media service server operated by an external business operator different from a service provider providing a navigation service for the computing device.

In some embodiments, the searching for the point of interest from the social media service server may include searching for the point of interest in real time from the social media service server.

In some embodiments, the searching for the point of interest in real time may include searching for a first point of interest, which is located on the route at a first time zone and is the point of interest of the group corresponding to the profile; and searching for a second point of interest, which is located on the route at a second time zone and is the point of interest of the group corresponding to the profile, the first time zone is a different time zone from the second time zone, and the first point of interest is a different point of interest from the second point of interest.

In some embodiments, the displaying of the searched point of interest may include further displaying information on at least one of a source social media service for the point of interest and a popularity level of the point of interest on an social media.

In some embodiments, the method may further comprise updating the route into a new route with the selected point of interest as a destination, in response to a user's selection input for the displayed point of interest.

According to another aspect of the present disclosure, there is provided a system for displaying a point of interest. The system may comprise a navigation system; a communication interface; a memory into which a computer program is loaded; and one or more processors on which the computer program is executed, wherein the computer program includes instructions that perform operations of: acquiring data regarding a user-specified route and the user's profile; searching for a point of interest of a group corresponding to the profile, the point of interest being located on the route; and displaying the searched point of interest on a map displayed by the navigation system.

In some embodiments, the operation of acquiring the data may include an operation of identifying a passenger riding inside a mobility device equipped with the computing device, and the data regarding the profile further includes data regarding the relationship between the passengers and the user, when the number of passengers is multiple.

In some embodiments, the data regarding the profile may further include data regarding an age range of the passenger, when the passenger is a child of the user as a result of performing the operation of identifying the passenger.

In some embodiments, the operation of acquiring the data may include an operation of acquiring data regarding a profile item selected by the user among the profile items included in an social media search filter.

In some embodiments, the operation of searching for the point of interest may include an operation of searching for the point of interest from an social media service server operated by an external business operator different from a service provider providing a navigation service for the computing device.

In some embodiments, the operation of searching for the point of interest from the social media service server may include an operation of searching for the point of interest in real time from the social media service server.

In some embodiments, the operation of searching for the point of interest in real time may include an operation of searching for a first point of interest, which is located on the route at a first time zone and is the point of interest of the group corresponding to the profile; and an operation of searching for a second point of interest, which is located on the route at a second time zone and is the point of interest of the group corresponding to the profile, the first time zone is a different time zone from the second time zone, and the first point of interest is a different point of interest from the second point of interest.

In some embodiments, the operation of displaying the searched point of interest may include an operation of further displaying information on at least one of a source social media service for the point of interest and a popularity level of the point of interest on an social media.

In some embodiments, the system may further comprise an operation of updating the route into a new route with the selected point of interest as a destination, in response to a user's selection input for the displayed point of interest.

According to still another aspect of the present disclosure, there is provided a computer program stored in a computer-readable recording medium coupled to a computing device to execute operations comprising: acquiring data regarding a user-specified route and the user's profile; searching for a point of interest of a group corresponding to the profile, the point of interest being located on the route; and displaying the searched point of interest on a map displayed by the computing device.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a system configuration diagram of a system for displaying a point of interest according to an exemplary embodiment of the present disclosure;

FIG. 2 is a flowchart illustrating a method for displaying a point of interest according to another exemplary embodiment of the present disclosure;

FIG. 3 is a diagram illustrating data regarding a user's profile, referenced in some exemplary embodiments of the present disclosure;

FIG. 4 is a diagram illustrating an social media search filter that may be performed in some exemplary embodiments of the present disclosure;

FIG. 5 is an exemplary diagram illustrating a method for searching and displaying a point of interest that may be performed in still another exemplary embodiment of the present disclosure;

FIG. 6 is an exemplary diagram illustrating a method for searching a point of interest that may be performed in still another exemplary embodiment of the present disclosure;

FIG. 7 is an exemplary diagram illustrating a method for searching and displaying a point of interest that may be performed in some exemplary embodiments of the present disclosure;

FIG. 8 is an exemplary diagram illustrating a method for displaying a point of interest that may be performed in still another exemplary embodiment of the present disclosure;

FIG. 9 is an exemplary diagram illustrating a method for updating to a new route according to still another exemplary embodiment of the present disclosure; and

FIG. 10 is a hardware configuration diagram of a computing system described in some exemplary embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, several embodiments of the present disclosure will be described with reference to the drawings.

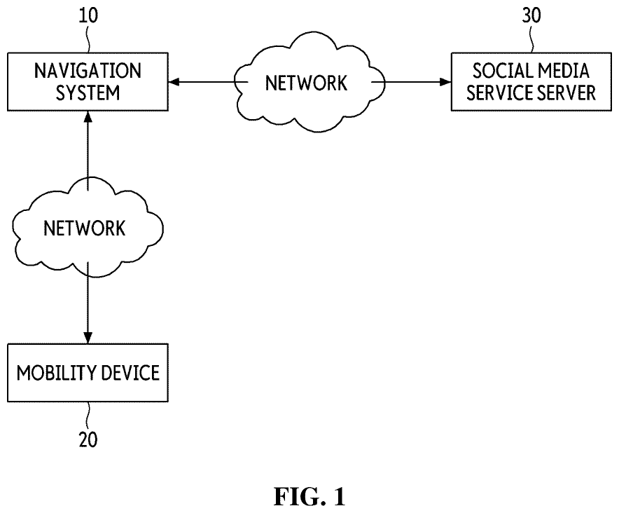

Hereinafter, the configuration and operation of a system for displaying a point of interest according to an exemplary embodiment of the present disclosure will be described with reference to FIG. 1. FIG. 1 is a system configuration diagram of a system for displaying a point of interest according to an exemplary embodiment of the present disclosure.

Referring to FIG. 1, a system 1 for displaying a point of interest may be configured to include a navigation system 10, a mobility device 20, and an social media service server 30. However, the scope of the present disclosure is not limited thereto. In some cases, the system 1 for displaying the point of interest may also be configured to further include modules/devices/systems not illustrated in FIG. 1. Alternatively, the system 1 for displaying the point of interest may also be configured in a form in which at least some of the components 10 to 30 illustrated in FIG. 1 are excluded.

The navigation system 10 may be a navigation system mounted on the mobility device 20. Alternatively, the navigation system 10 may be a terminal (e.g., a smartphone terminal) that operates in conjunction with the mobility device 20. The navigation system 10 may be a system that provides route guidance while the mobility device 20 is driving. The navigation system 10 may acquire data regarding a user-specified route and a user's profile, and may search for a point of interest of a user group corresponding to the user's profile on the social media service server 30 based on the acquired data. In this case, the social media service server 30 may be a server serviced by an external business operator different from a service provider providing a navigation service for the navigation system 10.

The navigation system 10 may display the point of interest searched through the social media service server 30 on a map displayed through a display unit mounted on the navigation system 10. In addition, the navigation system 10 may update the existing guided route into a new route with the selected point of interest as the destination or waypoint, in response to a user's selection input for the displayed point of interest, and guide the new route.

Meanwhile, in some exemplary embodiments, the navigation system 10, the mobility device 20, and the social media service server 30 may communicate through a network. Here, the network may be implemented as all types of wired/wireless networks such as a Local Area Network (LAN), a Wide Area Network (WAN), a mobile radio communication network, Wireless Broadband Internet (Wibro), and Bluetooth.

Hereinafter, in order to provide convenience of understanding, the description will be continued on the assumption that all steps/operations of the methods to be described later are performed in the above-described navigation system 10. Therefore, when a subject of a specific step/operation is omitted, it may be understood that the specific step/operation is performed in the navigation system 10. However, in a real environment, some steps/operations of the method to be described later may also be performed in other computing devices.

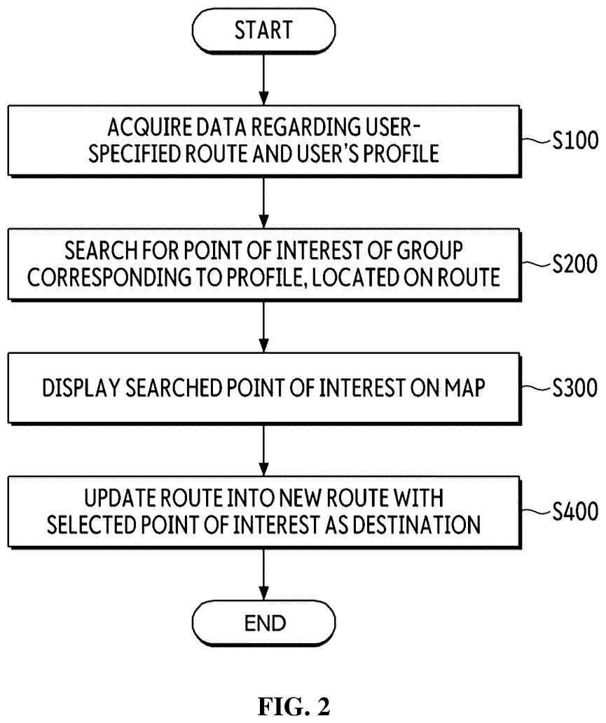

Hereinafter, a method for displaying a point of interest according to an exemplary embodiment of the present disclosure will be described with reference to FIG. 2. FIG. 2 is a flowchart illustrating a method for displaying a point of interest according to another exemplary embodiment of the present disclosure.

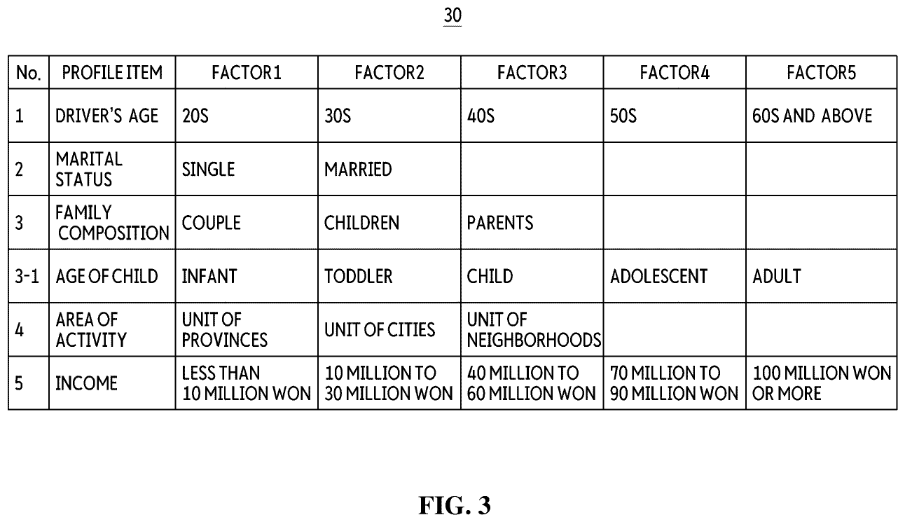

Referring to FIG. 2, the navigation system 10 may acquire data regarding a user-specified route and a user's profile (S100). The data regarding the route may include data regarding a current location of the navigation system 10, a destination specified by the user, and a route searched from the current location of the navigation system 10 to the destination. The data regarding the profile may be data revealing user's personal information. The data regarding the user's profile will be described in detail later with reference to FIG. 3.

Thereafter, the navigation system 10 may search for a point of interest in a group corresponding to the user's profile (S200). In this case, the point of interest being searched may be located on the user-specified route. The point of interest may be located within a preset distance from the user-specified route. For example, the preset distance may be set to a distance (e.g., 100 meters) that may be displayed within a map range displayed by the navigation system 10, but the scope of the present disclosure is not limited thereto.

The group corresponding to the user's profile may mean a group that matches all elements of the user's profile items acquired in step S100. In addition, the point of interest of the group corresponding to the user's profile may mean a hot place that the group has visited or sympathized with several times. However, it should be noted that the point of interest according to the present disclosure is not limited thereto.

Thereafter, the navigation system 10 may display the point of interest searched in step S200 on a map displayed by the navigation system 10 (S300).

Thereafter, the navigation system 10 may update the user-specified route into a new route with the selected point of interest as the destination or waypoint, in response to a user's selection input for the point of interest displayed in step S300 (S400). As a result, the user may easily get the updated route guidance by clicking on the point of interest.

According to the present exemplary embodiment, in providing the navigation service, the point of interest of the user group corresponding to the user's profile information may be searched and displayed on the map. Therefore, according to the present exemplary embodiment, there is an advantage in that user satisfaction with the navigation service may be increased.

Hereinafter, a method for acquiring data regarding a user's profile according to some exemplary embodiments of the present disclosure will be described.

First, data regarding a user's profile, referenced in some exemplary embodiments of the present disclosure, will be described with reference to FIG. 3. FIG. 3 is a diagram illustrating data regarding a user's profile, referenced in some exemplary embodiments of the present disclosure.

The data regarding the user's profile may include at least one of the user's age, the user's marital status, the user's area of activity, data regarding the user's annual income, and data regarding the user's family composition.

Referring to FIG. 3, a table 30 illustrating profile items and elements for profile items is illustrated.

The user's profile may consist of items regarding the driver's (=user's) age, the user's marital status, the user's family composition, the age of the user's child, the user's area of activity, and the user's income. The driver's age may be categorized into, for example, 20s, 30s, 40s, 50s, and 60s and above. The user's marital status may be classified as single or married. The user's family composition may be classified into a couple, children, and/or parents. The age of user's child may be categorized as infant (under 1 year old), toddler (1 year old or older but under 4 years old), child (4 years old or older but under 10 years old), adolescent (teenager), and/or adult (20 years old or older). The user's area of activity is an area the user primarily visits, and may be classified into the unit of provinces, the unit of cities, or the unit of neighborhoods. The user's income may be categorized into less than 10 million won, 10 million to 30 million won, 40 million to 60 million won, 70 million to 90 million won, and 100 million won or more.

In an exemplary embodiment, the data regarding the user's profile may be configured to include data based on a user input and data set by the navigation system 10. For example, among the profile items illustrated in FIG. 3, the data regarding the driver's age, the user's marital status, the user's area of activity, and the user's income may be data input by the user. That is, the user may provide the data regarding the profile by directly inputting the listed data.

On the other hand, among the profile items illustrated in FIG. 3, the data regarding the user's family composition and the age of the user's child may be data automatically set by the navigation system 10.

In an exemplary embodiment, the navigation system 10 may identify a passenger riding inside the mobility device 20 equipped with the navigation system 10. When there are multiple passengers riding inside the mobility device 20, that is, when there is another person riding inside the mobility device 20 other than the driver (=user), the navigation system 10 may further acquire data regarding the relationship between the passengers and the user by identifying the passengers.

The navigation system 10 may identify a passenger riding inside the mobility device 20 by using a camera mounted on the navigation system 10 itself or a camera mounted inside the mobility device 20 that operates in conjunction with the navigation system 10. For example, the navigation system 10 may identify whether the passenger is the spouse, child, or parent of the user (=driver) by recognizing a passenger's face using the camera mounted on the navigation system 10. The navigation system 10 may further acquire data regarding the relationship between the passenger and the user based on the passenger identification result.

In addition, in an exemplary embodiment, when the passenger is the user's child as the result of passenger identification, the navigation system 10 may further acquire data regarding an age range of the passenger. The age range of the passenger may be data pre-specified by the user. That is, the navigation system 10 may identify who the passenger is based on the passenger's facial recognition result, and data regarding the age range of the specified person may be acquired by referencing the data previously specified by the user.

That is, the two exemplary embodiments, the navigation system 10 may independently acquire the data regarding the relationship between the passenger and the user and the age range of the passenger when the passenger is the user's child by identifying the passenger using the camera mounted inside the navigation system 10 or the camera mounted inside the mobility device 20. The navigation system 10 may automatically set data regarding the user's family composition and the age of the user's child based on the acquired data regarding the relationship between the passenger and the user and the age range of the passenger.

According to the two exemplary embodiments, as the data regarding the user's profile diversifies, there is an advantage in that it allows for searching for a point of interest that is more suitable for the user's profile.

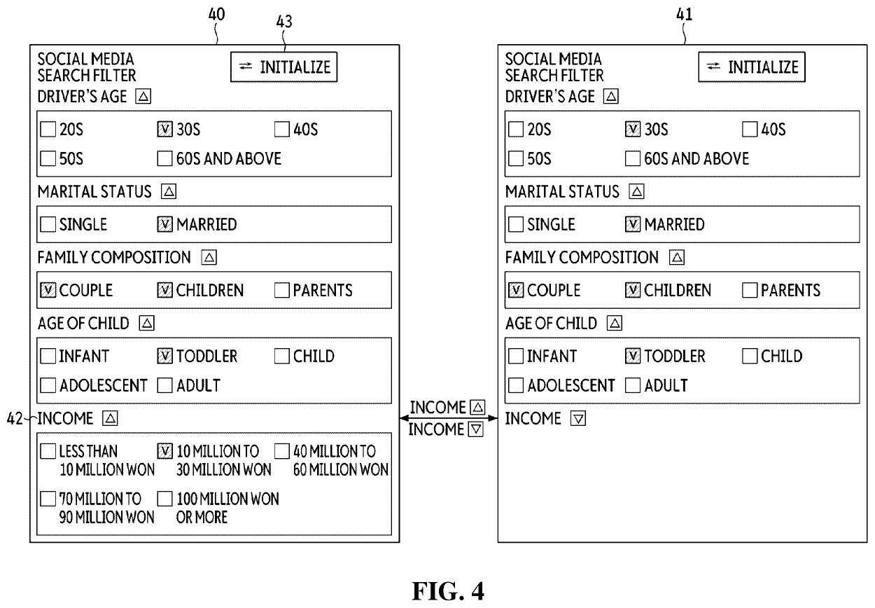

Next, an social media search filter that may be performed in some exemplary embodiments of the present disclosure will be described with reference to FIG. 4. FIG. 4 is a diagram illustrating an social media search filter that may be performed in some exemplary embodiments of the present disclosure.

Referring to FIG. 4, an social media search filter 40 that may be performed in some exemplary embodiments of the present disclosure is illustrated. The navigation system 10 may receive an input from the user by displaying the social media search filter 40 as a pop-up window on the displayed map. The social media search filter 40 includes each element of the user's profile item described above with reference to FIG. 3, and the user may select an element for each profile item by clicking on the element corresponding to the profile item. For example, the user may set the driver's age to 30s, marital status to married, and annual income to 10 to 30 million won. In addition, the navigation system 10 may identify that among the passengers riding inside the mobility device 20, a first passenger, excluding the driver who is the user, is a married couple with the user and a second passenger is a child, using the camera, etc. mounted on the navigation system 10. In addition, the navigation system 10 may identify that the second passenger is a toddler based on the data previously input by the user. The navigation system 10 may automatically set information on the user's family composition and the age range of the user based on the identified data.

When the user clicks an initialization button 43 on the social media search filter 40, the settings may be initialized to the user's profile registered as a basic user on the navigation system 10. For example, when the user's profile registered as the basic user indicates that the age range of the user is 30s, the marital status is married, and the annual income is 10 to 30 million won, the settings for the profile item elements checked on the social media search filter 40 may be initialized to the age range being the 30s, the marital status being married, and the annual income being 10 to 30 million won, if the user clicks the initialization button 43 on the social media search filter 40.

Meanwhile, in an exemplary embodiment, the navigation system 10 may acquire only data regarding a profile item selected by the user among the profile items included in the social media search filter. For example, referring to FIG. 4, the user may want their annual income to not be taken into account when searching for a point of interest of a group corresponding to their profile. In this case, when the user clicks on an icon located next to the profile item 42 regarding the annual income, the elements regarding the profile item 42 regarding the annual income, such as an social media search filter 41 on the right, may not be displayed to the user. The navigation system 10 may acquire only data input by the user or set by the navigation system 10, excluding the data regarding the profile item regarding the annual income.

According to the present exemplary embodiment, as the user may choose which data regarding the profile he or she wants to provide in acquiring the data regarding the user's profile, user's convenience of the navigation service may be improved.

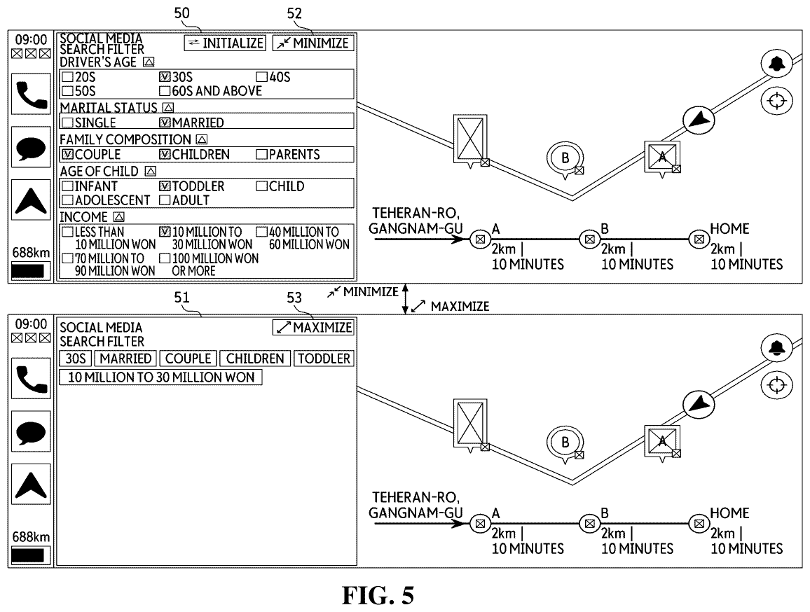

Meanwhile, in an exemplary embodiment, the navigation system 10 may display the social media search filter on a map displayed to the user. In this case, the social media search filter may be displayed in various forms. A method for displaying an social media search filter according to some exemplary embodiments of the present disclosure will be described with reference to FIG. 5. FIG. 5 is an exemplary diagram illustrating a method for searching and displaying a point of interest that may be performed in still another exemplary embodiment of the present disclosure.

Referring to FIG. 5, a screen with an social media search filter 50 maximized and a screen with an social media search filter 52 minimized are illustrated. When the social media search filter 50 is maximized, the navigation system 10 may display both elements for each profile item and elements for each profile item selected by the user. On the other hand, when the social media search filter 51 is minimized, the navigation system 10 may display only the elements for each profile item selected by the user.

When the user clicks the minimize button 52 in a state in which the social media search filter 50 is maximized, the social media search filter 50 may be minimized to display only the elements of each profile item selected by the user, like the social media search filter 51. On the other hand, when the user clicks the maximize button 53 in a state in which the social media search filter 51 is minimized, the social media search filter 51 may be maximized to display both elements for each profile item and elements for each profile item selected by the user, like the social media search filter 50.

Hereinafter, a method for searching for a point of interest of a group corresponding to a user's profile according to an exemplary embodiment of the present disclosure will be described.

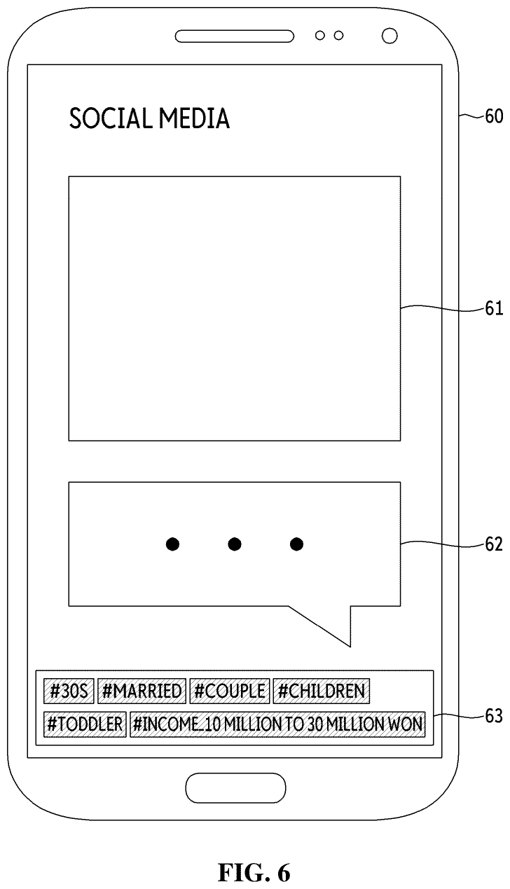

In an exemplary embodiment, the navigation system 10 may search for a point of interest in an social media service server operated by an external business operator different from a service provider that provides the navigation service for the navigation system 10. That is, the navigation system 10 may search for a point of interest of a group corresponding to the user's profile by searching a server that serves social networking services such as Instagram, Facebook, and TikTok using the data regarding the user's profile, A method for searching for a point of interest of a group corresponding to a user's profile will be described with reference to FIG. 6. FIG. 6 is an exemplary diagram illustrating a method for searching a point of interest that may be performed in still another exemplary embodiment of the present disclosure.

Referring to FIG. 6, a smartphone terminal 60 on which an social media application is executed is illustrated. In a first section 63 of an social media execution screen, the data regarding the user's profile is displayed in the form of a hashtag. For example, as the user's profile, the user's profile in his/her 30s, married, riding the mobility device 20 with his/her spouse and children, whose children are infants, and whose annual income is 10 to 30 million won is displayed in the first section 63. In this case, information (e.g., map information) or images regarding a hot place as a point of interest of the group corresponding to the user's profile displayed in the first section 63 may be displayed in a second section 61, and replies such as comments about the hot place may be displayed in a third section 62.

The navigation system 10 may perform a search on the social media service server 30 operated by an external business operator on behalf of the user, as illustrated in FIG. 6, using the data regarding the user's profile displayed in the first section 63. The navigation system 10 may display the point of interest acquired through the search results on the displayed map.

According to the present exemplary embodiment, by searching for a place corresponding to the user's profile information on the social media service server operated by the external business operator and displaying the place on the map without building a separate database in providing the navigation service, resources may be efficiently used, and at the same time, by recommending the recently popular hot place tailored to the user's profile, user convenience for navigation services may be maximized.

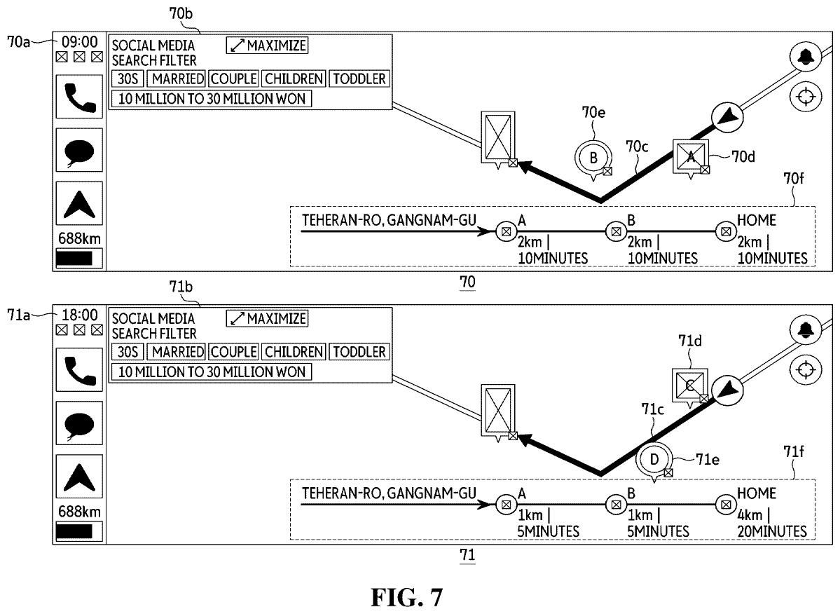

Meanwhile, in an exemplary embodiment, the navigation system 10 may search for the point of interest of the group corresponding to the user's profile in real time from the social media service server 30. That is, the navigation system 10 may search for a first point of interest located on a route specified by the user at a first time zone and which is the point of interest of the group corresponding to the acquired user's profile, and may search for a second point of interest located on a route specified by the user at a second time zone and which is the point of interest of the group corresponding to the acquired user's profile. In this case, the first time zone may be a different time zone from the second time zone, and the first point of interest may be different from the second point of interest. A method for the navigation system 10 to search for a point of interest in real time will be described with reference to FIG. 7. FIG. 7 is an exemplary diagram illustrating a method for searching a point of interest that may be performed in still another exemplary embodiment of the present disclosure.

Referring to FIG. 7, a first navigation screen 70 that displays a point of interest searched at 09:00, which is the first time zone, and a second navigation screen 71 that displays a point of interest searched at 18:00, which is the second time zone, are illustrated. Referring to the first navigation screen 70 and the second navigation screen 71, routes 70c and 71c set on each screen and the data 70b and 71b regarding the user's profile match, and the search time zone is 09:00, which is a first time zone 70a, in the case of the first navigation screen 70, and is 18:00, which is a second time zone 71a, in the case of the second navigation screen 71.

The first points of interest, which are located on the user-specified route 70c in the first time zone 70a and are points of interest of a group corresponding to the input profile 70b, are A 70d and B 70e. On the other hand, the second points of interest, which are located on the user-specified route 71c in the second time zone 71a and are points of interest of a group corresponding to the input profile 71b, are C 71d and D 71e.

The navigation system 10 may display a first floating bar 70f regarding the time and distance required to reach the points of interest A 70d and B 70e from a current location of the mobility device 20 on the first navigation screen 70. The navigation system 10 may display a second floating bar 71f regarding the time and distance required to reach the points of interest C 71d and D 71e from the current location of the mobility device 20 on the second navigation screen 71.

That is, according to the present exemplary embodiment, the points of interest searched for may be different depending on the time zone in which the navigation system 10 searches for the points of interest. Therefore, according to the present exemplary embodiment, the usability of the navigation service may be maximized by searching for the points of interest of the group corresponding to the user's profile in real time and providing optimal search results.

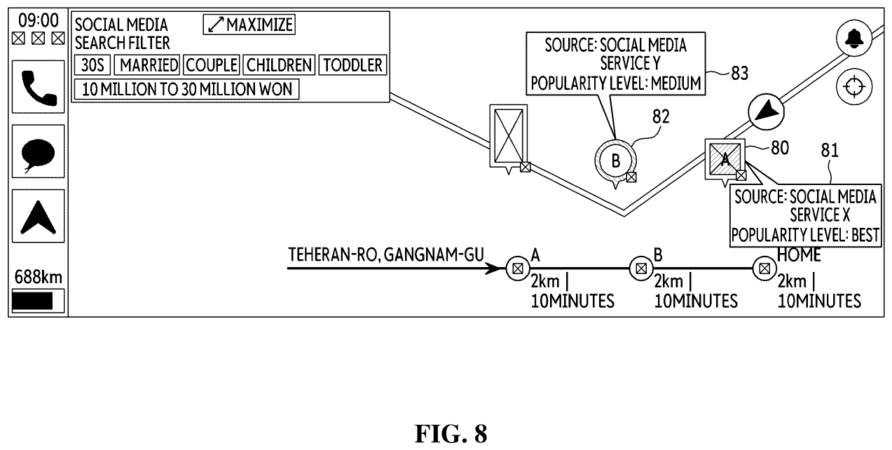

Hereinafter, a method for displaying a point of interest according to an exemplary embodiment of the present disclosure will be described with reference to FIG. 8. FIG. 8 is an exemplary diagram illustrating a method for displaying a point of interest that may be performed in still another exemplary embodiment of the present disclosure.

In an exemplary embodiment, the navigation system 10 may further display information on at least one of a source social media service for the searched point of interest and a popularity level of the searched point of interest on an social media. Referring to FIG. 8, it is assumed that the points of interest located on the user-specified route and of the group corresponding to the user's profile and are A 80 and B 82. In this case, the navigation system 10 may display information 81 that a source social media service for the point of interest A 80 is an social media service X and that a popularity level thereof is the highest. In addition, the navigation system 10 may display the point of interest A 80 so that the user may recognize more easily the point of interest A 80 by highlighting an area around an indicator for the point of interest A 80 displayed on the map.

Likewise, the navigation system 10 may display information 83 that a source social media service for the point of interest B 82 is an social media service Y and that a popularity level thereof is medium. In addition, the navigation system 10 may display the point of interest B 82 so that the user may recognize more easily the point of interest B 82 by highlighting an area around an indicator for the point of interest B 82 displayed on the map.

According to the present exemplary embodiment, by visually displaying the source and popularity level of the searched points of interest, the user may more easily recognize the points of interest, and the reliability of the points of interest may increase.

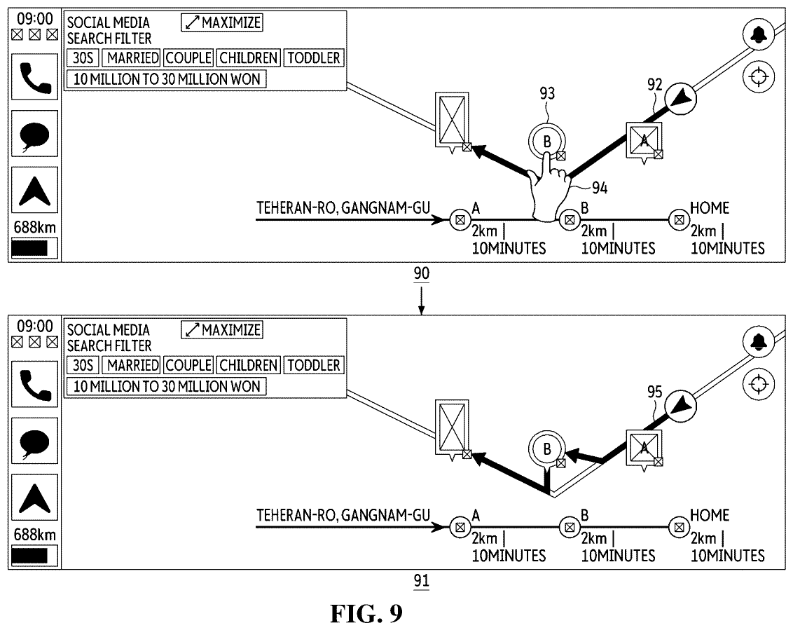

Next, a method for updating a route according to an exemplary embodiment of the present disclosure will be described with reference to FIG. 9. FIG. 9 is an exemplary diagram illustrating a method for updating to a new route according to still another exemplary embodiment of the present disclosure.

In an exemplary embodiment, the navigation system 10 may update a preset route with a new route with a selected point of interest as a destination or waypoint, in response to a user's selection input for the point of interest displayed on the displayed map.

Referring to FIG. 9, a first screen 90 on which the points of interest are displayed on the map and a second screen 91 on which the user selects a point of interest displayed on the map are illustrated. Referring to the first screen 90, the points searched as the points of interest located on a first route 92 specified by the user and of the group corresponding to the user's profile are A and B 93. In this case, when the user selects the point of interest B 93, the navigation system 10 may update the first route 92 to a second route 95 with a point of interest B 93 as a waypoint, which is displayed on the second screen 91.

According to the present exemplary embodiment, as the route is updated depending on the user's selection input, it is easier for the user to operate the navigation system.

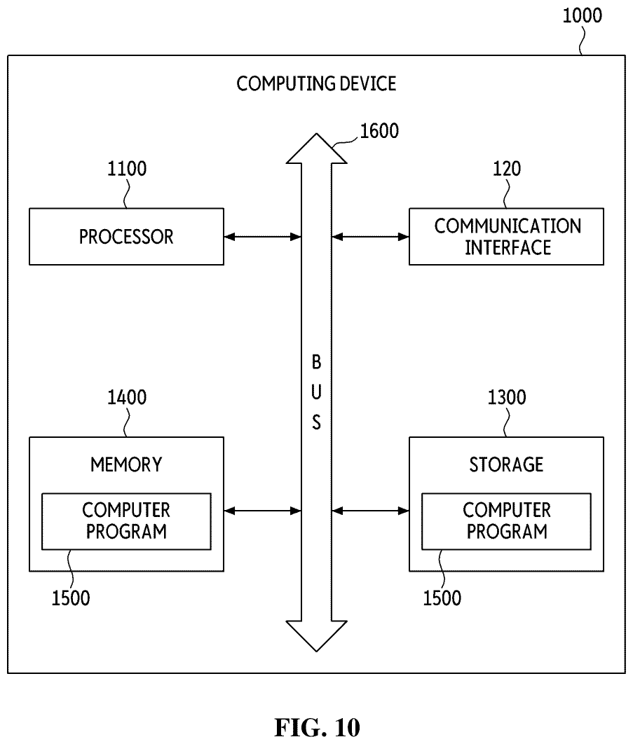

FIG. 10 is a hardware configuration diagram of a computing system according to some exemplary embodiments of the present disclosure. A computing system 1000 of FIG. 10 may include one or more processors 1100, a system bus 1600, a communication interface 1200, a memory 1400 for loading a computer program 1500 executed by the processor 1100, and a storage 1300 for storing the computer program 1500.

The computing system 1000 of FIG. 10 may present a hardware structure of one or more computing systems constituting the navigation system 10 described with reference to FIG. 1, for example.

The processor 1100 controls the overall operation of each component of the computing system 1000. The processor 1100 may perform a calculation on at least one application or program for executing the methods/operations according to various exemplary embodiments of the present disclosure. The memory 1400 stores various data, instructions, and/or information. The memory 1400 may load one or more programs 1500 from the storage 1300 to execute the methods/operations according to various exemplary embodiments of the present disclosure. The storage 1300 may non-temporarily store one or more computer programs 1500.

The computer program 1500 may include one or more instructions in which the methods/operations according to various exemplary embodiments of the present disclosure are implemented. When the computer program 1500 is loaded into the memory 1400, the processor 1100 may perform the methods/operations according to various exemplary embodiments of the present disclosure by executing the one or more instructions.

In an exemplary embodiment, the computer program 1500 may include instructions of performing an operation of acquiring data about a user-specified route and the user's profile, an operation of searching for a point of interest of a group corresponding to the profile, the point of interest being located on the route, and an operation of displaying the searched point of interest on a map displayed by the computing device.

So far, a variety of embodiments of the present disclosure and the effects according to embodiments thereof have been mentioned with reference to FIGS. 1 to 10. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for displaying a point of interest, performed by a computing device, the method comprising:
acquiring data regarding a user-specified route and a user profile;
searching for a point of interest of a group corresponding to the user profile, wherein the point of interest is located on the user-specified route; and
displaying the point of interest on a map displayed by the computing device.

2. The method of claim 1, wherein the data regarding the user profile includes a data input by a user of the user profile and a data set by the computing device.

3. The method of claim 1, wherein the acquiring the data includes identifying a passenger riding inside a mobility device equipped with the computing device, and wherein the data regarding the user profile further includes data regarding a relationship between the passenger and a user of the user profile.

4. The method of claim 3, wherein the data regarding the user profile further includes a data regarding an age range of the passenger when the passenger is a child of the user.

5. The method of claim 1, wherein the acquiring the data includes acquiring data regarding a profile item selected by a user of the user profile among a plurality of profile items included in a social media search filter.

6. The method of claim 1, wherein the searching for the point of interest includes searching for the point of interest from a social media service server operated by an external business operator different from a service provider providing a navigation service for the computing device.

7. The method of claim 6, wherein the searching for the point of interest from the social media service server includes searching for the point of interest in real time from the social media service server.

8. The method of claim 7, wherein the searching for the point of interest in real time includes:
searching for a first point of interest, which is located on the user-specified route at a first time zone and is the point of interest of the group corresponding to the user profile; and
searching for a second point of interest, which is located on the user-specified route at a second time zone and is the point of interest of the group corresponding to the user profile, wherein the first time zone is different from the second time zone, and wherein the first point of interest is different from the second point of interest.

9. The method of claim 1, wherein the displaying of the point of interest includes further displaying on a social media an information on a source social media service for the point of interest or an information on a popularity level of the point of interest.

10. The method of claim 1, further comprising updating the user-specified route into a new route with the point of interest selected as a destination in response to a user input.

11. A system for displaying a point of interest, the system comprising:
a navigation system;
a communication interface;
a memory into which a computer program is loaded; and
at least one processor on which the computer program is executed,
wherein the computer program includes instructions that perform operations of:
acquiring data regarding a user-specified route and a user profile;
searching for a point of interest of a group corresponding to the user profile, wherein the point of interest is located on the user-specified route; and
displaying the point of interest on a map displayed by the navigation system.

12. The system of claim 11, wherein the operation of acquiring the data includes an operation of identifying a passenger riding inside a mobility device equipped with the computing device, and wherein the data regarding the user profile further includes data regarding a relationship between the passenger and a user of the user profile.

13. The system of claim 12, wherein the data regarding the user profile further includes a data regarding an age range of the passenger when the passenger is a child of the user.

14. The system of claim 11, wherein the operation of acquiring the data includes an operation of acquiring data regarding a profile item selected by a user of the user profile among a plurality of profile items included in a social media search filter.

15. The system of claim 11, wherein the operation of searching for the point of interest includes an operation of searching for the point of interest from a social media service server operated by an external business operator different from a service provider providing a navigation service for the computing device.

16. The system of claim 15, wherein the operation of searching for the point of interest from the social media service server includes an operation of searching for the point of interest in real time from the social media service server.

17. The system of claim 16, wherein the operation of searching for the point of interest in real time includes:
an operation of searching for a first point of interest, which is located on the user-specified route at a first time zone and is the point of interest of the group corresponding to the user profile; and
an operation of searching for a second point of interest, which is located on the user-specified route at a second time zone and is the point of interest of the group corresponding to the user profile, wherein the first time zone is different from the second time zone, and wherein the first point of interest is different from the second point of interest.

18. The system of claim 11, wherein the operation of displaying the searched point of interest includes an operation of further displaying on a social media an information on a source social media service for the point of interest or an information on a popularity level of the point of interest.

19. The system of claim 11, further comprising an operation of updating the user-specified route into a new route with the point of interest selected as a destination in response to a user input.

20. A non-transitory computer-readable medium, comprising a set of instructions stored thereon, that when executed by a processor, the set of instructions perform a method comprising:
acquiring data regarding a user-specified route and a user profile;
searching for a point of interest of a group corresponding to the user profile, wherein the point of interest is located on the user-specified route; and
displaying the point of interest on a map displayed by the computing device.
